(19) United States
(12) Patent Application Publication
(10) Pub. No.: US 2025/0386391 A1
(43) Pub. Date: Dec. 18, 2025

(54) Mobile Terminated Small Data Transmission

(71) Applicant: Telefonaktiebolaget LM Ericsson (publ), Stockholm (SE)

(72) Inventors: Liwei Qiu, Täby (SE); Jan Christoffersson, Luleå (SE); Yazid Lyazidi, Hässelby (SE)

(21) Appl. No.: 18/877,365

(22) PCT Filed: Jul. 3, 2023
(86) PCT No.: PCT/SE2023/050689

§ 371 Date: Dec. 20, 2024

Related U.S. Application Data
(60) Provisional application No. 63/389,394, filed on Jul. 15, 2022.

(51) Int. Cl. H04W 76/20; H04W 68/02; H04W 76/19

(52) U.S. Cl. CPC H04W 76/20; H04W 68/02; H04W 76/19

(57) ABSTRACT

In an example, a method performed by a network node for forwarding data to a RAN node for transmitting a Mobile Terminated Small Data Transmission (MT-SDT) to a User Equipment (UE) is disclosed. The method comprises determining data to be sent to a User Equipment (UE) in a Mobile Terminated Small Data Transmission (MT-SDT), and sending, to a first Radio Access Network (RAN) node associated with a last serving cell for the UE, a paging request and an indication that the data is pending. The method also comprises determining that the UE has responded to the paging request, and forwarding the data to a second RAN node for transmitting the MT-SDT to the UE, wherein the second RAN node is associated with a cell that received a response to the paging request from the UE.

### TECHNICAL FIELD

Examples of this disclosure relate to mobile terminated small data transmission (MT-SDT), for example forwarding data to a Radio Access Network (RAN) node for transmitting a MT-SDT to a User Equipment (UE), or causing transmission of a MT-SDT to a UE.

### BACKGROUND

NR small data transmissions in Inactive state

A Work Item RP-200954 ‘New Work Item on NR small data transmissions in INACTIVE state’ has been approved in 3GPP with the focus of optimizing the transmission for small data payloads by reducing the signaling overhead. The Work Item (WI) contains the following objectives:

This work item enables small data transmission in RRC_INACTIVE state as follows: For the RRC_INACTIVE state:
uplink (UL) small data transmissions for RACH-based schemes (i.e. 2-step and 4-step random access channel, RACH):
   General procedure to enable UP data transmission for small data packets from INACTIVE state (e.g. using MSGA or MSG3) [RAN2]
   Enable flexible payload sizes larger than the Rel-16 CCCH message size that is possible currently for INACTIVE state for MSGA and MSG3 to support UP data transmission in UL (actual payload size can be up to network configuration) [RAN2]
   Context fetch and data forwarding (with and without anchor relocation) in INACTIVE state for RACH-based solutions [RAN2, RAN3]
   Note 1: The security aspects of the above solutions should be checked with SA3
Transmission of UL data on pre-configured PUSCH resources (i.e. reusing the configured grant type 1)—when TA is valid
   General procedure for small data transmission over configured grant type 1 resources from INACTIVE state [RAN2]
   Configuration of the configured grant type1 resources for small data transmission in UL for INACTIVE state [RAN2]

The Small Data Transmission (SDT) procedure in New Radio (NR) Rel-17 is only for MO (Mobile Originated)-SDT meaning that it is only triggered by uplink (UL) data transmissions.

For narrowband internet of things (NB-IoT) and LTE-M User Equipments (UEs), similar signaling optimizations for small data transmission have been introduced through Rel-15 Early Data Transmission (EDT) and Rel-16 Preconfigured Uplink Resources (PUR). The main differences for the New Radio (NR) SDT solutions are that the Rel-17 NR Small Data is only to be supported for UEs in the RRC INACTIVE state, and also includes 2-step RACH based small data, and that it should also support regular complexity MBB UEs. Both support MO traffic only. NR SDT, unlike LTE EDT, also supports transmission of subsequent data, that is larger payload sizes which require more than one transmission.

Random access SDT (RA-SDT) means that either legacy 4-step RACH or 2-step RACH procedure is used as a baseline but that a user-plane data payload can be appended (multiplexed with the RRCResumeRequest message) in Msg3 (or MsgA). Configured grant SDT (CG-SDT) means that UEs can be configured via RRC to have periodic CG-SDT occasions which can, contention-free, be used for uplink transmission. In this way, Msg1 and Msg2 can be omitted but it is a requirement that the UE has a valid Timing Advance (TA) and is uplink synchronized to be able to use the resources for transmission.

### Transmission of UL Data on Pre-Configured PUSCH Resources, MO CG-SDT Procedure

The CG-SDT procedure uses CG PUSCH resources that are PUSCH resources configured in advance for the UE. When there is uplink data available at the UE's buffer, it can immediately start uplink transmission using the pre-configured PUSCH resources without waiting for an UL grant from the gNB, thus reducing the latency. NR supports CG type 1 PUSCH transmission and CG type 2 PUSCH transmission. For both types, the PUSCH resources (time and frequency allocation, periodicity, etc.) are preconfigured via dedicated RRC signaling. The CG type 1 PUSCH transmission is activated/deactivated by RRC signaling, while the CG type 2 PUSCH transmission is activated/deactivated by an UL grant using downlink control information (DCI) signaling. For Small Data transmissions, it has been agreed that CG type 1 is used.

According to the RAN2 agreements in Rel-17 for CG-SDT, the CG-SDT configuration will be sent to the UE in a RRCRelease message and will specify associations between CG resources (transmission opportunities) and synchronization signal blocks (SSBs). The UE will, upon initiating the CG-SDT procedure, select an SSB with SS-RSRP above a configured reference signal received power (RSRP) threshold. The initial CG-SDT transmission will contain the RRCResumeRequest multiplexed with data and possibly a buffer status report (BSR) MAC control element (CE), and possibly a power headroom report (PHR) MAC CE. If the gNB receives the transmission successfully, it will reply with dynamic scheduling of uplink new transmission for the same HARQ process as acknowledgement or possibly with a downlink (DL) data transmission. After this, the UE may use the following CG-SDT resources for transmission of new UL data after successful timing advance (TA) validation and SSB selection. The TA validation means that the CG-SDT-TA timer is running and the change of the SS-RSRP(s) are within configured thresholds. The CG-SDT procedure is terminated when the CG-SDT-TA timer expires, the UE reselects to a different cell or the gNB sends a RRCResume or RRCRelease to the UE.

For LTE, support for mobile terminated traffic (MT) was introduced in Rel-16.

NR MT-SDT is being introduced in Rel-18. A Rel-18 MT-SDT work item description (WID) was approved in RAN #94e (December 2021) and can be found in RP-213583. The WID contains the following objectives:
Specify the support for paging-triggered SDT (MT-SDT) [RAN2, RAN3]
   MT-SDT triggering mechanism for UEs in RRC_INACTIVE, supporting RA-SDT and CG-SDT as the UL response;
   MT-SDT procedure for initial DL data reception and subsequent UL/DL data transmissions in RRC_INACTIVE.
Note: Data transmission in DL within paging message is not in scope of this WI.

The exact procedure is to be defined but a probable baseline procedure can be expected to be as follows:
1. DL data triggers an MT-SDT procedure in the network.
2. Network pages UE.
3. UE responds to the paging by initiating an SDT procedure, either CG-SDT or RA-SDT. This means that the UE sends an RRCResumeRequest message.
4. The network (NW) (after contention resolution in case of RA-SDT) schedules a DL transmission including the data that triggered the MT-SDT procedure.
5. The UE may optionally acknowledge the DL transmission.
6. The NW either moves the UE to connected mode or releases the UE to Idle or Inactive mode.

An example of baseline procedures for RA-SDT is shown in FIG. 1 and for CG-SDT in FIG. 2. In both cases, UE triggers SDT upon reception of paging.

### Paging Procedure for Inactive UEs

In RRC_INACTIVE, RAN paging is used for DL reachability, at the same time UE still monitors core network (CN) paging but this is a fail-safe mechanism in case of state mismatch. When DL data arrives in the CN for a UE in the RRC_INACTIVE state, the data will be forwarded to the last serving gNB which has the UE's context. If the UE is located in any of the cells of the last serving gNB, it is the last serving gNB that will be responsible for the paging. In case of split gNB, the paging message is sent from the anchor gNB-CU to its gNB-DUs.

If the UE is located in another gNB (i.e. a neighbor gNB, here referred to as ‘paging gNB’), the last serving gNB will send a paging message over Xn to the other gNBs configured in the RAN Notification Area (RNA) upon network's implementation, which in turn will send (F1) paging messages in their cells. When the UE receives the paging, it will trigger a random access (RA) procedure in the cell where it is camping.

There currently exist certain challenge(s). For example, MT-EDT was introduced for LTE in Rel-16. However, for the introduction of MT-SDT for NR in Rel-18 there are some substantial differences, mainly due to that UEs are restricted to RRC_INACTIVE state and that RAN paging is used. RAN paging is carried out over XnAP in the RAN Paging area and also in the F1 Paging message sent from gNB-CU to the gNB-DU where the cells are located so that the paging can be sent to the UE over the air interface (Uu). In some cases, the UE is not located in the same last cell (e.g. last serving cell) when it was released to RRC_INACTIVE, or when the UE has moved to a cell belonging to a different NG-RAN node. If the DL data is being buffered at the 5G Core Network (5GCN), assuming that the receiving gNB decides whether to trigger MT-SDT, the receiving gNB cannot trigger MT-SDT since it has not received the DL data at the time when the paging message is sent.

### SUMMARY

Certain aspects of the disclosure and their embodiments may provide solutions to these or other challenges. For example, example embodiments may transfer buffered data or MT-SDT from a Core Network to a RAN node, and then a network entity (e.g. the RAN node) initiates an MT-SDT procedure to the UE.

Example embodiments may provide enhancements to existing signaling (e.g. NGAP signalling) or define new signalling (e.g. NGAP signalling) to enable transferring the possibly buffered mobile-terminated small data from the Core Network (CN), and the procedures and signaling (e.g. XnAP and/or F1AP) may enable the use of MT-SDT for delivery of DL data.

In some examples, the enhancement is that CN sends a request to the RAN (e.g. NG-RAN) to trigger RAN Paging for the UE that has downlink (DL) MT-SDT data pending.

Certain embodiments may provide one or more of the following technical advantage(s). For example, embodiments may enable triggering of MT-SDT procedure in a RAN node (e.g. NG-RAN node) in case Core Network is aware of the small data. No impacts on the UE are foreseen.

A first example aspect of the present disclosure provides a method performed by a network node for forwarding data to a RAN node for transmitting a Mobile Terminated Small Data Transmission (MT-SDT) to a User Equipment (UE). The method comprises determining data to be sent to a User Equipment (UE) in a Mobile Terminated Small Data Transmission (MT-SDT) and sending, to a first Radio Access Network (RAN) node associated with a last serving cell for the UE, a paging request and an indication that the data is pending. The method also comprises determining that the UE has responded to the paging request, and forwarding the data to a second RAN node for transmitting the MT-SDT to the UE, wherein the second RAN node is associated with a cell that received a response to the paging request from the UE.

Another example aspect of the present disclosure provides a method in a first Radio Access Network (RAN) node of causing transmission of a Mobile Terminated Small Data Transmission (MT-SDT) to a User Equipment (UE). The method comprises receiving a paging request for a User Equipment (UE) and an indication that data is pending for transmission to the UE as a Mobile Terminated Small Data Transmission (MT-SDT), and transmitting the paging request to the UE. The method also comprises determining that the UE has responded to the paging request, and ausing the data to be forwarded from a network node to a second RAN node for transmitting the MT-SDT to the UE, wherein the second RAN node is associated with a cell that received a response to the paging request from the UE.

### BRIEF DESCRIPTION OF THE DRAWINGS

For a better understanding of the embodiments of the present disclosure, and to show how it may be put into effect, reference will now be made, by way of example only, to the accompanying drawings, in which:

FIG. 1 illustrates an example of baseline procedures for RA-SDT;

FIG. 2 illustrates an example of baseline procedures for CG-SDT;

FIG. 3 depicts a method in accordance with particular embodiments;

FIG. 4 depicts another method in accordance with particular embodiments;

FIG. 5 shows an example of messaging in a network according to examples of this disclosure;

FIG. 6 shows an example of a communication system in accordance with some embodiments;

FIG. 7 shows a UE in accordance with some embodiments;

FIG. 8 shows a network node in accordance with some embodiments;

FIG. 9 is a block diagram of a host in accordance with various aspects described herein;

FIG. 10 is a block diagram illustrating a virtualization environment in which functions implemented by some embodiments may be virtualized; and

FIG. 11 shows a communication diagram of a host communicating via a network node with a UE over a partially wireless connection in accordance with some embodiments.

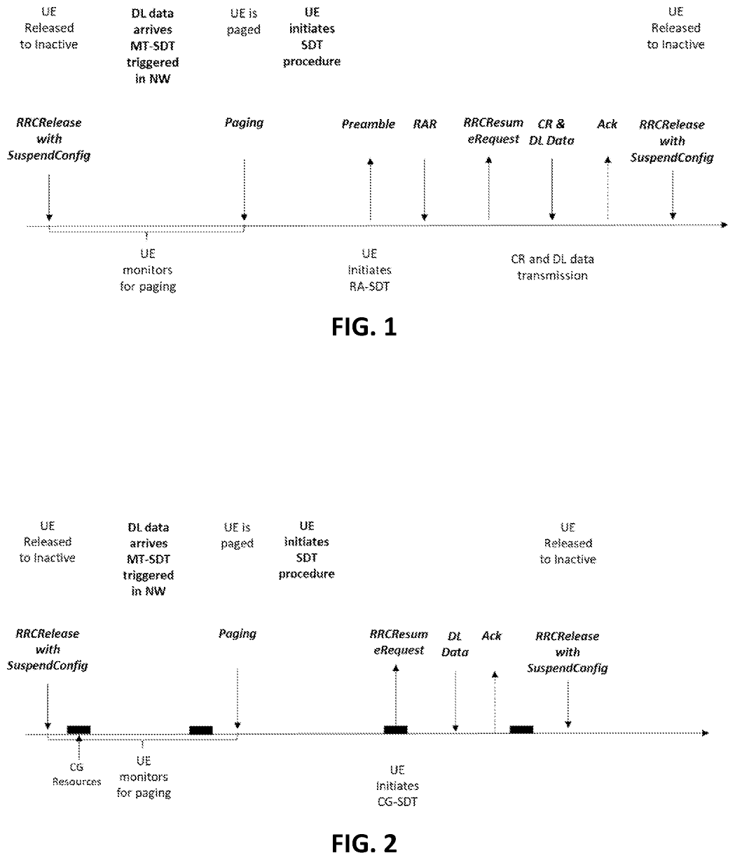

### DETAILED DESCRIPTION

The following sets forth specific details, such as particular embodiments or examples for purposes of explanation and not limitation. It will be appreciated by one skilled in the art that other examples may be employed apart from these specific details. In some instances, detailed descriptions of well-known methods, nodes, interfaces, circuits, and devices are omitted so as not obscure the description with unnecessary detail. Those skilled in the art will appreciate that the functions described may be implemented in one or more nodes using hardware circuitry (e.g. analog and/or discrete logic gates interconnected to perform a specialized function, Application Specific Integrated Circuits (ASICs), Programmable Logic Arrays (PLAs), etc.) and/or using software programs and data in conjunction with one or more digital microprocessors or general purpose computers. Nodes that communicate using the air interface also have suitable radio communications circuitry. Moreover, where appropriate the technology can additionally be considered to be embodied entirely within any form of computer-readable memory, such as solid-state memory, magnetic disk, or optical disk containing an appropriate set of computer instructions that would cause a processor to carry out the techniques described herein.

Hardware implementation may include or encompass, without limitation, digital signal processor (DSP) hardware, a reduced instruction set processor, hardware (e.g. digital or analogue) circuitry including but not limited to application specific integrated circuit(s) (ASIC) and/or field programmable gate array(s) (FPGA(s)), and (where appropriate) state machines capable of performing such functions.

Some of the embodiments contemplated herein will now be described more fully with reference to the accompanying drawings. Embodiments are provided by way of example to convey the scope of the subject matter to those skilled in the art.

As indicated above, example embodiments may transfer buffered data or MT-SDT from a Core Network to a RAN node, and then a network entity (e.g. the RAN node) initiates an MT-SDT procedure to the UE.

Example embodiments may provide enhancements to existing signaling (e.g. NGAP signalling) or define new signalling (e.g. NGAP signalling) to enable transferring the possibly buffered mobile-terminated small data from the Core Network (CN), and the procedures and signaling (e.g. XnAP and/or F1AP) may enable the use of MT-SDT for delivery of DL data.

For example, the mobile-terminated small data may be buffered in the Core Network (e.g. in AMF), and in case of anchor node relocation, the RAN node informs the CN, so that the CN sends a message (e.g. NGAP message) to the new RAN node (e.g. the cell that is now the serving cell for the UE or on which the UE is camped) for transferring the data to the UE with some new indications, for example over NG-AP and/or F1AP.

In case of MT-SDT without anchor node relocation (i.e., the UE context stays at last serving gNB), the CN may in some examples send a message (e.g. NGAP message) to the old RAN node (e.g. associated with a last serving cell for the UE) for transferring the data to the UE with some new indications, for example over NG-AP, XnAP and/or F1AP.

In some examples, the enhancement is that CN sends a request to the RAN (e.g. NG-RAN) to trigger RAN Paging for the UE that has downlink (DL) MT-SDT data pending.

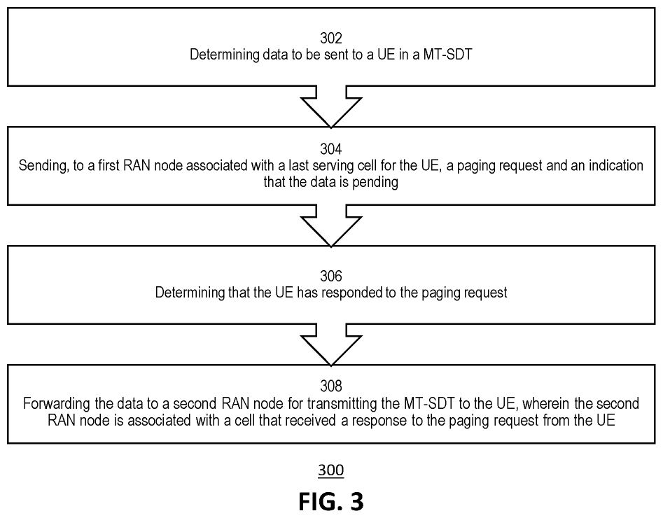

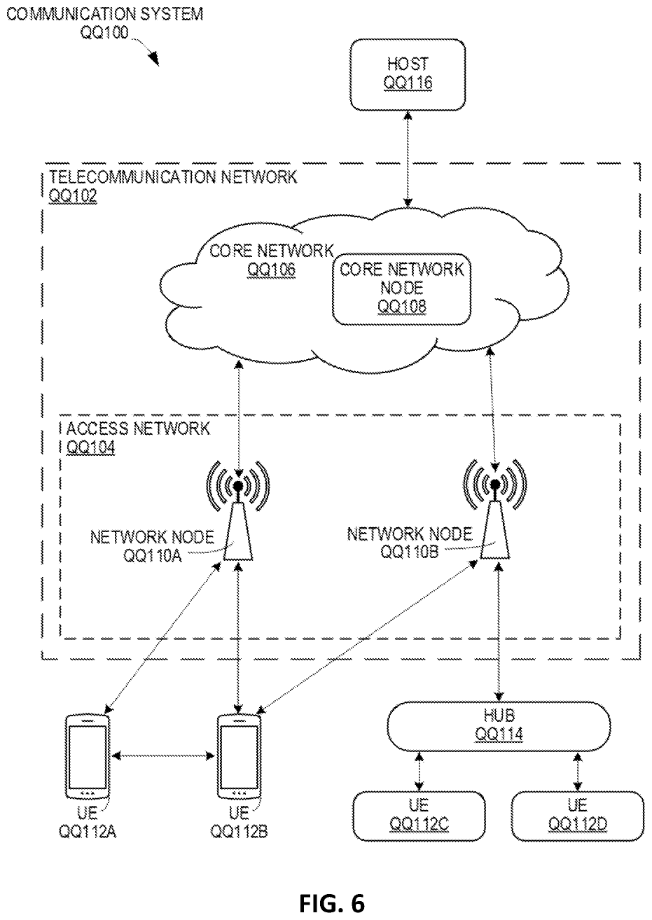

FIG. 3 depicts a method 300 in accordance with particular embodiments, for example a method performed by a network node for forwarding data to a RAN node for transmitting a Mobile Terminated Small Data Transmission (MT-SDT) to a User Equipment (UE). The method 300 may be performed by a network node (e.g. the network node QQ110 or network node QQ300 as described later with reference to FIGS. 6 and 8 respectively). The method 300 begins at step 302 with determining data to be sent to a User Equipment (UE) in a Mobile Terminated Small Data Transmission (MT-SDT), and then step 304 with sending, to a first Radio Access Network (RAN) node associated with a last serving cell for the UE, a paging request and an indication that the data is pending. Next, step 306 comprises determining that the UE has responded to the paging request, and step 308 comprises forwarding the data to a second RAN node for transmitting the MT-SDT to the UE, wherein the second RAN node is associated with a cell that received a response to the paging request from the UE.

The first RAN node may be for example an anchor RAN node for the UE, a base station, base station control unit (CU), eNodeB (eNB), eNB-CU, gNodeB (gNB) or gNB-CU. Additionally or alternatively, the second RAN node may be for example an anchor RAN node for the UE, a base station, base station control unit (CU), eNodeB (eNB), eNB-CU, gNodeB (gNB) or gNB-CU. Additionally or alternatively, the network node may be for example an Access and Mobility Management Function (AMF).

In some examples, the first RAN node is the same RAN node as the second RAN node. In such examples, determining that the UE has responded to the paging request may comprise at least one of the following:
receiving, from the first RAN node, an indication that the UE has responded to the paging request;
receiving, from the first RAN node, an indication that the UE is camping on the cell that received the response to the paging request from the UE;
receiving, from the first RAN node, an indication that the cell that received the response to the paging request from the UE is a serving cell or a current serving cell for the UE; and/or
receiving, from the first RAN node, an indication that the UE has connected to or resumed in the first RAN node.

In other examples, the first RAN node is a different RAN node to the second RAN node. In such examples, determining that the UE has responded to the paging request may comprise at least one of:
receiving a path switch request for the UE from the first or second RAN node;
receiving an indication from the first RAN node that the first RAN node has received, from the second RAN node, a request to retrieve a full or partial context of the UE;
receiving, from the second RAN node, a request to retrieve a full or partial context of the UE from the first RAN node;
receiving, from the second RAN node, an indication that the UE is camping on the cell that received the response to the paging request from the UE;
receiving, from the second RAN node, an indication that the cell that received the response to the paging request from the UE is a serving cell or a current serving cell for the UE; and/or
receiving, from the second RAN node, an indication that the UE has connected to or resumed in the second RAN node.

Determining that the UE has responded to the paging request in step 306 of the method 300 may in some examples comprise receiving, from the second RAN node, the request to retrieve the full or partial context of the UE from the first RAN node. In such examples, the method 300 may comprise forwarding the request to retrieve the full or partial context to the second RAN node, and forwarding, to the first RAN node, a response to the request to retrieve the full or partial context.

In some examples, the method 300 comprises sending, to the first RAN node, with the indication that the data is pending, information identifying UE expected traffic pattern or behavior after the data is transmitted to the UE.

The paging request and/or the indication that the MT-SDT is pending may be sent for example to the first RAN node in a NG Application Protocol (NGAP) message.

In some examples, determining that the UE has responded to the paging request comprises determining that the UE is in an active state, has resumed a connection to the second network node, and/or is reachable. Additionally or alternatively, in some examples, determining that the UE has responded to the paging request comprises receiving an indication that the UE has responded to the paging request. The indication that the UE has responded to the paging request may be received for example from the first RAN node or the second RAN node.

The indication may in some examples be sent in the paging request, and/or the indication may comprise for example a service or bearer category and/or an indication of a Data Radio Bearer (DRB). The paging request may in some examples indicate an amount of data for transmission to the UE, and the indication may comprise or indicate a non-zero amount of data.

In some examples, the cell that received a response to the paging request from the UE comprises a current serving cell (or a last serving cell) for the UE or a cell on which the UE is camped.

The response from the UE to the paging request may comprise for example a random access preamble, RRC resume request, RRC connection request, Msg1, Msg3 and/or MsgA.

Determining the data to be sent to the UE in step 302 of the method 300 may in some examples comprise receiving the data from another network node.

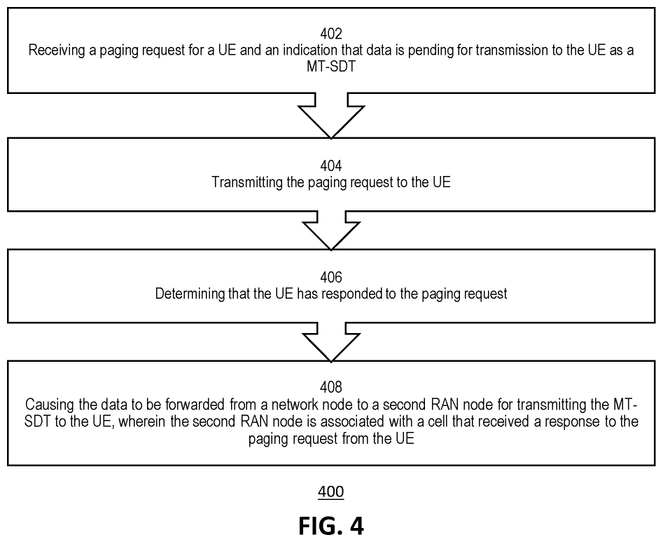

FIG. 4 depicts a method 400 in accordance with particular embodiments, for example a method in a first Radio Access Network (RAN) node of causing transmission of a Mobile Terminated Small Data Transmission (MT-SDT) to a User Equipment (UE). The method 400 may be performed by a network node (e.g. the network node QQ110 or network node QQ300 as described later with reference to FIGS. 6 and 8 respectively). The method 400 begins at step 402 with receiving a paging request for a User Equipment (UE) and an indication that data is pending for transmission to the UE as a Mobile Terminated Small Data Transmission (MT-SDT), and step 404 with transmitting the paging request to the UE. Next, step 406 comprises determining that the UE has responded to the paging request, and step 408 comprises causing the data to be forwarded from a network node to a second RAN node for transmitting the MT-SDT to the UE, wherein the second RAN node is associated with a cell that received a response to the paging request from the UE.

The first RAN node may be for example an anchor RAN node for the UE, a base station, base station control unit (CU), eNodeB (eNB), eNB-CU, gNodeB (gNB) or gNB-CU. Additionally or alternatively, the second RAN node may be for example an anchor RAN node for the UE, a base station, base station control unit (CU), eNodeB (eNB), eNB-CU, gNodeB (gNB) or gNB-CU. Additionally or alternatively, the network node may be for example an Access and Mobility Management Function (AMF).

In some examples, the first RAN node is not associated with a last serving cell for the UE, and the paging request is associated with another RAN node that is associated with the last serving cell for the UE. In such examples, causing the data to be forwarded from a network node to a second RAN node for transmitting the MT-SDT to the UE may comprise for example sending a request for a full or partial context for the UE to the another RAN node or the network node.

In some examples, the first RAN node is a different RAN node to the second RAN node. For example, the first RAN node may be associated with a last serving cell for the UE. In such examples, determining that the UE has responded to the paging request in step 406 of the method 400 may comprise receiving, from the network node or the second RAN node, a request to retrieve a full or partial context for the UE. In some examples, causing the data to be forwarded from a network node to a second RAN node for transmitting the MT-SDT to the UE in step 408 of the method 100 may comprise sending, to the network node, an indication that the request to retrieve the full or partial context of the UE has been received from the second RAN node.

In some examples, causing the data to be forwarded from a network node to a second RAN node for transmitting the MT-SDT to the UE step 408 of the method 100 may comprise at least one of the following:
sending, to the network node, an indication that the UE has responded to the paging request;
sending, to the network node, an indication that the UE is camping on the cell that received the response to the paging request from the UE;
sending, to the network node, an indication that the cell that received the response to the paging request from the UE is a serving cell or a current serving cell for the UE;
sending, to the network node, an indication that the UE has connected to or resumed in the second RAN node; and/or
sending a path switch request to the network node.

The method 400 may in some examples comprise receiving the paging request from the network node, the second RAN node, or another RAN node that is associated with the last serving cell for the UE. Additionally or alternatively, the method 400 may in some examples comprise receiving, from the network node, with the indication that the data is pending, information identifying UE expected traffic pattern or behavior after the data is transmitted to the UE.

The paging request and/or the indication that the MT-SDT is pending may in some examples be received from the network node in a NG Application Protocol (NGAP) message.

The indication may be received in the paging request in some examples. The paging request may for example indicate an amount of data for transmission to the UE, where the indication comprises a non-zero amount of data, and/or the indication may comprise for example a service or bearer category and/or an indication of a Data Radio Bearer (DRB).

In some examples, the response from the UE to the paging request comprises a random access preamble, RRC resume request, RRC connection request, Msg1, Msg3 and/or MsgA.

Some particular example embodiments will now be described. Each example embodiment may be combined with any one or more of any other example embodiments, where appropriate.

Case of MT-SDT with Anchor Relocation

In some examples, such as those of MT-SDT with anchor relocation, the Core Network (CN) decides to buffer the MT-SDT before it transfers the data to the NG-RAN node (e.g. the second RAN node referred to herein). In some examples, the Core Network (CN) buffers the DL data for MT-SDT until CN considers the UE reachable or when it receives an indication from the new NG-RAN node, e.g. after the NGAP PATH SWITCH REQUEST message, that the UE has resumed in a new node, or otherwise has responded to a paging request.

In another example, the old anchor node (e.g. associated with a last serving cell for the UE, which may be e.g. the first RAN node referred to herein) notifies the 5G CN that it has received a Retrieve UE Context Request from the new gNB which it will accept, i.e. relocate the context to the new requesting gNB. By this signaling, the CN will understand that the UE is reachable and has resumed and is ready for a MT-SDT transmission in a (yet unknown) cell (e.g. associated with the second RAN node referred to herein) and that it can send the data once it receives the PATH SWITCH request.

In one example embodiment, the CN includes a MT-SDT indication in an existing message, such as a NGAP message, e.g. in the PATH SWITCH REQUEST ACKNOWLEDGE message towards the NG-RAN node. In one alternative example embodiment, the CN includes a MT-SDT indication in a new NGAP message. Based on the received information, the target gNB (e.g. the second RAN node referred to herein) sends the DL small data to UE, e.g. transmits the MT-SDT.

Case of MT-SDT without Anchor Relocation

In one example embodiment, the Core Network buffers the DL data for MT-SDT. When CN considers the UE reachable, it sends a message (e.g. NGAP message, paging request) including a MT-SDT indication towards the NG-RAN node.

The anchor gNB (e.g. the first RAN node referred to herein) receiving the CN's MT-SDT indication signals it for example over Xn to the receiving gNB (e.g. the second RAN node referred to herein) where the UE is camping (e.g. the cell that received the response to a paging request as referred to herein). Such signalling can be e.g. over the XnAP PARTIAL UE CONTEXT TRANSFER message.

In one example embodiment, the receiving gNB sends a XnAP PARTIAL UE CONTEXT TRANSFER ACKNOWLEDGE message to the anchor gNB to inform about its decision of sending the DL small data to UE. In another example embodiment, the anchor gNB sends an indication to the Core Network either using existing message or a new message to trigger DL small data transmission.

### Other Examples

One or more of the features in the following examples may in some examples be combined with one or more features of the case of MT-SDT with anchor relocation described above, and/or one or more features of the case of MT-SDT without anchor relocation as described above.

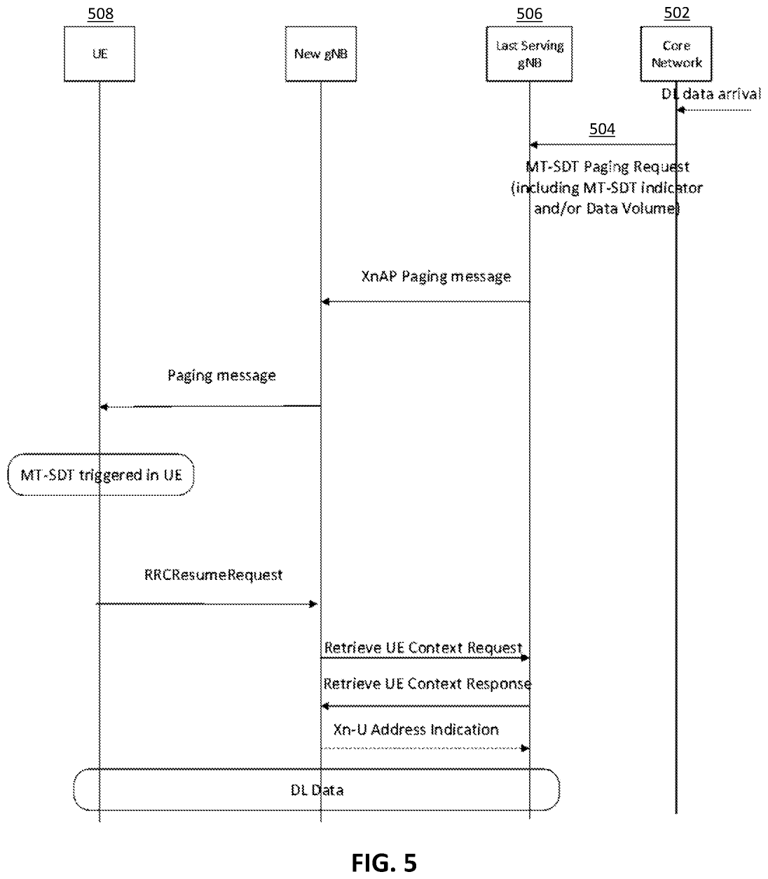

FIG. 5 shows an example of messaging in a network according to examples of this disclosure. As depicted in FIG. 5 below, CN 502 sends a new message 504 (e.g. over N2 signaling) to last serving gNB 506 to trigger RAN paging of the UE 508 that has pending small data with a new MT-SDT indication.

In some examples, the MT-SDT indication in message 504 is an explicit enumerated value, e.g. ENUMERATED (true, . . . ), or an implicit indication, e.g. “data volume” represented by a number of bits (which may for example be non-zero for the case where there is data to be transmitted as a MT-SDT). In some examples, a data volume indicator may be used as MT-SDT indication, e.g. a few signaling bits are used to indicate the size of the DL data.

In some examples, the MT-SDT indication refers to a service or bearer category, for example through its Quality of Service (QOS) or Protocol Data Unit (PDU) session association. For example, indication of a data radio bearer (DRB) may indicate that there is DL data suited for MT-SDT on that DRB, i.e. an implicit indication.

In some examples, the CN may include additional information, together with an explicit or implicit MT-SDT indication, on UE expected traffic pattern or behavior after initiating SDT procedure. The receiving NG-RAN node may use this information to decide whether to initiate MT-SDT with the RAN paging procedure. This could in some examples be seen as network assistance information, e.g. not only the DL data volume is used for determining the suitability of MT-SDT, but also whether more data is expected.

In some example generic embodiments, absence of the MT-SDT indication from the initiating network entity (e.g. CN) can be interpreted by the receiving network entity (NG-RAN node) as an indication to proceed with legacy paging.

Without loss of generality, below is provided a non-limiting example for including the MT-SDT indication (implicitly and explicitly) over new NGAP MT SDT Paging Request message in TS 38.413:

### 9.2.4.1 MT SDT Paging Request

This message is sent by the AMF and is used to request triggering RAN paging a UE that has pending MT-SDT.
Direction: AMF to NG-RAN node

| | | | | | | |
|---|---|---|---|---|---|---|
| | | | IE type and | Semantics | | Assigned |
| IE/Group Name | Presence | Range | reference | description | Criticality | Criticality |

| | | | | | |
|---|---|---|---|---|---|
| Message Type | M | 9.3.1.1 | | YES | ignore |
| MT-SDT | O | ENUMERATED | | YES | ignore |
| Indication | | (true, . . . ) | | | |
| (explicit option) | | | | | |
| Data Volume | O | INTEGER(1 . . . N) | N: maximum | YES | ignore |
| size (implicit | | | number of | | |
| option) | | | bits for the | | |
| | | | data | | |
| MT-SDT | O | ENUMERATED | | YES | ignore |
| Assistance | | (single SDT, | | | |
| Information | | multiple SDT) | | | |

In some examples, supplementary paging information may be sent over the F1 interface or the Xn interface.

In some examples, to help the NG-RAN node deciding to trigger MT-SDT procedure, the NG-RAN node may need to retrieve UE context for MT-SDT via the CN in certain cases, e.g. no Xn connection between the NG-RAN nodes (the last serving gNB and the new gNB). In some examples, the RAN node (e.g. the new gNB, or the second RAN node) sends a UE context retrieval request message to the CN, e.g. a new indicator in the existing NGAP message, or a new message.

In some examples, the first NG-RAN node (e.g. the last serving gNB, or the RAN node associated with the last serving cell) receives the UE context retrieval request message from the other (e.g. second) NG-RAN node via CN, and decides to send a response message to the CN including the UE context related information. In one example option, the UE context related information is the full UE context. In another example option, the UE context related information is a partial UE context. The former option may be used for example for the anchor relocation, and the latter for example for the non-anchor relocation case.

In another example, the CN may decide where to forward the UE context retrieval request message based on the node identifier, and which node to respond to by a UE context retrieval response message with the related UE context.

In another example, when the CN decides to forward the UE context retrieval response to the first NG-RAN node, it includes the data buffered for the UE.

In another example, when the CN decides to forward the UE context retrieval response to the first NG-RAN node, it performs a path switch and sends a path switch response to the first NG-RAN node. In another example embodiment, the CN sends a UE context retrieval failure message to the second NG-RAN node if operation fails, e.g. no UE context is found.

FIG. 6 shows an example of a communication system QQ100 in accordance with some embodiments. In the example, the communication system QQ100 includes a telecommunication network QQ102 that includes an access network QQ104, such as a radio access network (RAN), and a core network QQ106, which includes one or more core network nodes QQ108. The access network QQ104 includes one or more access network nodes, such as network nodes QQ110a and QQ110b (one or more of which may be generally referred to as network nodes QQ110), or any other similar 3^{rd} Generation Partnership Project (3GPP) access node or non-3GPP access point. The network nodes QQ110 facilitate direct or indirect connection of user equipment (UE), such as by connecting UEs QQ112a, QQ112b, QQ112c, and QQ112d (one or more of which may be generally referred to as UEs QQ112) to the core network QQ106 over one or more wireless connections.

Example wireless communications over a wireless connection include transmitting and/or receiving wireless signals using electromagnetic waves, radio waves, infrared waves, and/or other types of signals suitable for conveying information without the use of wires, cables, or other material conductors. Moreover, in different embodiments, the communication system QQ100 may include any number of wired or wireless networks, network nodes, UEs, and/or any other components or systems that may facilitate or participate in the communication of data and/or signals whether via wired or wireless connections. The communication system QQ100 may include and/or interface with any type of communication, telecommunication, data, cellular, radio network, and/or other similar type of system.

The UEs QQ112 may be any of a wide variety of communication devices, including wireless devices arranged, configured, and/or operable to communicate wirelessly with the network nodes QQ110 and other communication devices. Similarly, the network nodes QQ110 are arranged, capable, configured, and/or operable to communicate directly or indirectly with the UEs QQ112 and/or with other network nodes or equipment in the telecommunication network QQ102 to enable and/or provide network access, such as wireless network access, and/or to perform other functions, such as administration in the telecommunication network QQ102.

In the depicted example, the core network QQ106 connects the network nodes QQ110 to one or more hosts, such as host QQ116. These connections may be direct or indirect via one or more intermediary networks or devices. In other examples, network nodes may be directly coupled to hosts. The core network QQ106 includes one more core network nodes (e.g. core network node QQ108) that are structured with hardware and software components. Features of these components may be substantially similar to those described with respect to the UEs, network nodes, and/or hosts, such that the descriptions thereof are generally applicable to the corresponding components of the core network node QQ108. Example core network nodes include functions of one or more of a Mobile Switching Center (MSC), Mobility Management Entity (MME), Home Subscriber Server (HSS), Access and Mobility Management Function (AMF), Session Management Function (SMF), Authentication Server Function (AUSF), Subscription Identifier De-concealing function (SIDF), Unified Data Management (UDM), Security Edge Protection Proxy (SEPP), Network Exposure Function (NEF), and/or a User Plane Function (UPF).

The host QQ116 may be under the ownership or control of a service provider other than an operator or provider of the access network QQ104 and/or the telecommunication network QQ102, and may be operated by the service provider or on behalf of the service provider. The host QQ116 may host a variety of applications to provide one or more services. Examples of such applications include the provision of live and/or pre-recorded audio/video content, data collection services, for example, retrieving and compiling data on various ambient conditions detected by a plurality of UEs, analytics functionality, social media, functions for controlling or otherwise interacting with remote devices, functions for an alarm and surveillance center, or any other such function performed by a server.

As a whole, the communication system QQ100 of FIG. 6 enables connectivity between the UEs, network nodes, and hosts. In that sense, the communication system may be configured to operate according to predefined rules or procedures, such as specific standards that include, but are not limited to: Global System for Mobile Communications (GSM); Universal Mobile Telecommunications System (UMTS); Long Term Evolution (LTE), and/or other suitable 2G, 3G, 4G, 5G standards, or any applicable future generation standard (e.g. 6G); wireless local area network (WLAN) standards, such as the Institute of Electrical and Electronics Engineers (IEEE) 802.11 standards (WiFi); and/or any other appropriate wireless communication standard, such as the Worldwide Interoperability for Microwave Access (WiMax), Bluetooth, Z-Wave, Near Field Communication (NFC) ZigBee, LiFi, and/or any low-power wide-area network (LPWAN) standards such as LoRa and Sigfox.

In some examples, the telecommunication network QQ102 is a cellular network that implements 3GPP standardized features. Accordingly, the telecommunications network QQ102 may support network slicing to provide different logical networks to different devices that are connected to the telecommunication network QQ102. For example, the telecommunications network QQ102 may provide Ultra Reliable Low Latency Communication (URLLC) services to some UEs, while providing Enhanced Mobile Broadband (eMBB) services to other UEs, and/or Massive Machine Type Communication (mMTC)/Massive IoT services to yet further UEs.

In some examples, the UEs QQ112 are configured to transmit and/or receive information without direct human interaction. For instance, a UE may be designed to transmit information to the access network QQ104 on a predetermined schedule, when triggered by an internal or external event, or in response to requests from the access network QQ104. Additionally, a UE may be configured for operating in single- or multi-RAT or multi-standard mode. For example, a UE may operate with any one or combination of Wi-Fi, NR (New Radio) and LTE, i.e. being configured for multi-radio dual connectivity (MR-DC), such as E-UTRAN (Evolved-UMTS Terrestrial Radio Access Network) New Radio-Dual Connectivity (EN-DC).

In the example illustrated in FIG. 6, the hub QQ114 communicates with the access network QQ104 to facilitate indirect communication between one or more UEs (e.g. UE QQ112c and/or QQ112d) and network nodes (e.g. network node QQ110b). In some examples, the hub QQ114 may be a controller, router, a content source and analytics node, or any of the other communication devices described herein regarding UEs. For example, the hub QQ114 may be a broadband router enabling access to the core network QQ106 for the UEs. As another example, the hub QQ114 may be a controller that sends commands or instructions to one or more actuators in the UEs. Commands or instructions may be received from the UEs, network nodes QQ110, or by executable code, script, process, or other instructions in the hub QQ114. As another example, the hub QQ114 may be a data collector that acts as temporary storage for UE data and, in some embodiments, may perform analysis or other processing of the data. As another example, the hub QQ114 may be a content source. For example, for a UE that is a VR headset, display, loudspeaker or other media delivery device, the hub QQ114 may retrieve VR assets, video, audio, or other media or data related to sensory information via a network node, which the hub QQ114 then provides to the UE either directly, after performing local processing, and/or after adding additional local content. In still another example, the hub QQ114 acts as a proxy server or orchestrator for the UEs, in particular in if one or more of the UEs are low energy IoT devices.

The hub QQ114 may have a constant/persistent or intermittent connection to the network node QQ110b. The hub QQ114 may also allow for a different communication scheme and/or schedule between the hub QQ114 and UEs (e.g. UE QQ112c and/or QQ112d), and between the hub QQ114 and the core network QQ106. In other examples, the hub QQ114 is connected to the core network QQ106 and/or one or more UEs via a wired connection. Moreover, the hub QQ114 may be configured to connect to an M2M service provider over the access network QQ104 and/or to another UE over a direct connection. In some scenarios, UEs may establish a wireless connection with the network nodes QQ110 while still connected via the hub QQ114 via a wired or wireless connection. In some embodiments, the hub QQ114 may be a dedicated hub—that is, a hub whose primary function is to route communications to/from the UEs from/to the network node QQ110b. In other embodiments, the hub QQ114 may be a non-dedicated hub—that is, a device which is capable of operating to route communications between the UEs and network node QQ110b, but which is additionally capable of operating as a communication start and/or end point for certain data channels.

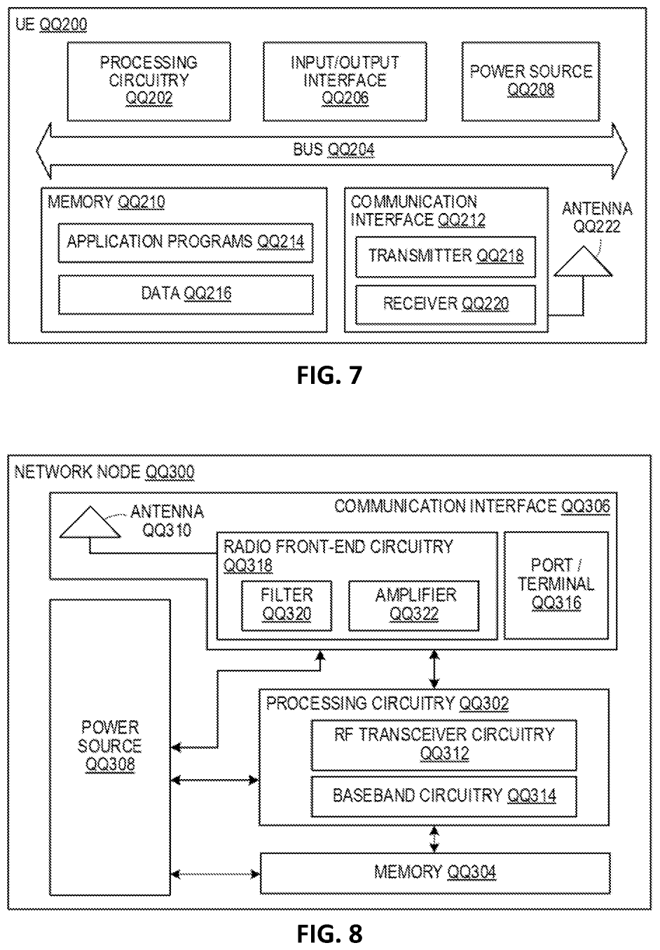

FIG. 7 shows a UE QQ200 in accordance with some embodiments. As used herein, a UE refers to a device capable, configured, arranged and/or operable to communicate wirelessly with network nodes and/or other UEs. Examples of a UE include, but are not limited to, a smart phone, mobile phone, cell phone, voice over IP (VOIP) phone, wireless local loop phone, desktop computer, personal digital assistant (PDA), wireless camera, gaming console or device, music storage device, playback appliance, wearable terminal device, wireless endpoint, mobile station, tablet, laptop, laptop-embedded equipment (LEE), laptop-mounted equipment (LME), smart device, wireless customer-premise equipment (CPE), vehicle-mounted or vehicle embedded/integrated wireless device, etc. Other examples include any UE identified by the 3rd Generation Partnership Project (3GPP), including a narrow band internet of things (NB-IoT) UE, a machine type communication (MTC) UE, and/or an enhanced MTC (eMTC) UE.

A UE may support device-to-device (D2D) communication, for example by implementing a 3GPP standard for sidelink communication, Dedicated Short-Range Communication (DSRC), vehicle-to-vehicle (V2V), vehicle-to-infrastructure (V2I), or vehicle-to-everything (V2X). In other examples, a UE may not necessarily have a user in the sense of a human user who owns and/or operates the relevant device. Instead, a UE may represent a device that is intended for sale to, or operation by, a human user but which may not, or which may not initially, be associated with a specific human user (e.g. a smart sprinkler controller). Alternatively, a UE may represent a device that is not intended for sale to, or operation by, an end user but which may be associated with or operated for the benefit of a user (e.g. a smart power meter).

The UE QQ200 includes processing circuitry QQ202 that is operatively coupled via a bus QQ204 to an input/output interface QQ206, a power source QQ208, a memory QQ210, a communication interface QQ212, and/or any other component, or any combination thereof. Certain UEs may utilize all or a subset of the components shown in FIG. 7. The level of integration between the components may vary from one UE to another UE. Further, certain UEs may contain multiple instances of a component, such as multiple processors, memories, transceivers, transmitters, receivers, etc.

The processing circuitry QQ202 is configured to process instructions and data and may be configured to implement any sequential state machine operative to execute instructions stored as machine-readable computer programs in the memory QQ210. The processing circuitry QQ202 may be implemented as one or more hardware-implemented state machines (e.g. in discrete logic, field-programmable gate arrays (FPGAs), application specific integrated circuits (ASICs), etc.); programmable logic together with appropriate firmware; one or more stored computer programs, general-purpose processors, such as a microprocessor or digital signal processor (DSP), together with appropriate software; or any combination of the above. For example, the processing circuitry QQ202 may include multiple central processing units (CPUs). The processing circuitry QQ202 may be operable to provide, either alone or in conjunction with other UE QQ200 components, such as the memory QQ210, UE QQ200 functionality.

In the example, the input/output interface QQ206 may be configured to provide an interface or interfaces to an input device, output device, or one or more input and/or output devices. Examples of an output device include a speaker, a sound card, a video card, a display, a monitor, a printer, an actuator, an emitter, a smartcard, another output device, or any combination thereof. An input device may allow a user to capture information into the UE QQ200. Examples of an input device include a touch-sensitive or presence-sensitive display, a camera (e.g. a digital camera, a digital video camera, a web camera, etc.), a microphone, a sensor, a mouse, a trackball, a directional pad, a trackpad, a scroll wheel, a smartcard, and the like. The presence-sensitive display may include a capacitive or resistive touch sensor to sense input from a user. A sensor may be, for instance, an accelerometer, a gyroscope, a tilt sensor, a force sensor, a magnetometer, an optical sensor, a proximity sensor, a biometric sensor, etc., or any combination thereof. An output device may use the same type of interface port as an input device. For example, a Universal Serial Bus (USB) port may be used to provide an input device and an output device.

In some embodiments, the power source QQ208 is structured as a battery or battery pack. Other types of power sources, such as an external power source (e.g. an electricity outlet), photovoltaic device, or power cell, may be used. The power source QQ208 may further include power circuitry for delivering power from the power source QQ208 itself, and/or an external power source, to the various parts of the UE QQ200 via input circuitry or an interface such as an electrical power cable. Delivering power may be, for example, for charging of the power source QQ208. Power circuitry may perform any formatting, converting, or other modification to the power from the power source QQ208 to make the power suitable for the respective components of the UE QQ200 to which power is supplied.

The memory QQ210 may be or be configured to include memory such as random access memory (RAM), read-only memory (ROM), programmable read-only memory (PROM), erasable programmable read-only memory (EPROM), electrically erasable programmable read-only memory (EEPROM), magnetic disks, optical disks, hard disks, removable cartridges, flash drives, and so forth. In one example, the memory QQ210 includes one or more application programs QQ214, such as an operating system, web browser application, a widget, gadget engine, or other application, and corresponding data QQ216. The memory QQ210 may store, for use by the UE QQ200, any of a variety of various operating systems or combinations of operating systems.

The memory QQ210 may be configured to include a number of physical drive units, such as redundant array of independent disks (RAID), flash memory, USB flash drive, external hard disk drive, thumb drive, pen drive, key drive, high-density digital versatile disc (HD-DVD) optical disc drive, internal hard disk drive, Blu-Ray optical disc drive, holographic digital data storage (HDDS) optical disc drive, external mini-dual in-line memory module (DIMM), synchronous dynamic random access memory (SDRAM), external micro-DIMM SDRAM, smartcard memory such as tamper resistant module in the form of a universal integrated circuit card (UICC) including one or more subscriber identity modules (SIMs), such as a USIM and/or ISIM, other memory, or any combination thereof. The UICC may for example be an embedded UICC (eUICC), integrated UICC (iUICC) or a removable UICC commonly known as ‘SIM card.’ The memory QQ210 may allow the UE QQ200 to access instructions, application programs and the like, stored on transitory or non-transitory memory media, to off-load data, or to upload data. An article of manufacture, such as one utilizing a communication system may be tangibly embodied as or in the memory QQ210, which may be or comprise a device-readable storage medium.

The processing circuitry QQ202 may be configured to communicate with an access network or other network using the communication interface QQ212. The communication interface QQ212 may comprise one or more communication subsystems and may include or be communicatively coupled to an antenna QQ222. The communication interface QQ212 may include one or more transceivers used to communicate, such as by communicating with one or more remote transceivers of another device capable of wireless communication (e.g. another UE or a network node in an access network). Each transceiver may include a transmitter QQ218 and/or a receiver QQ220 appropriate to provide network communications (e.g. optical, electrical, frequency allocations, and so forth). Moreover, the transmitter QQ218 and receiver QQ220 may be coupled to one or more antennas (e.g. antenna QQ222) and may share circuit components, software or firmware, or alternatively be implemented separately.

In some embodiments, communication functions of the communication interface QQ212 may include cellular communication, Wi-Fi communication, LPWAN communication, data communication, voice communication, multimedia communication, short-range communications such as Bluetooth, near-field communication, location-based communication such as the use of the global positioning system (GPS) to determine a location, another like communication function, or any combination thereof. Communications may be implemented in according to one or more communication protocols and/or standards, such as IEEE 802.11, Code Division Multiplexing Access (CDMA), Wideband Code Division Multiple Access (WCDMA), GSM, LTE, New Radio (NR), UMTS, WiMax, Ethernet, transmission control protocol/internet protocol (TCP/IP), synchronous optical networking (SONET), Asynchronous Transfer Mode (ATM), QUIC, Hypertext Transfer Protocol (HTTP), and so forth.

Regardless of the type of sensor, a UE may provide an output of data captured by its sensors, through its communication interface QQ212, via a wireless connection to a network node. Data captured by sensors of a UE can be communicated through a wireless connection to a network node via another UE. The output may be periodic (e.g. once every 15 minutes if it reports the sensed temperature), random (e.g. to even out the load from reporting from several sensors), in response to a triggering event (e.g. when moisture is detected an alert is sent), in response to a request (e.g. a user initiated request), or a continuous stream (e.g. a live video feed of a patient).

As another example, a UE comprises an actuator, a motor, or a switch, related to a communication interface configured to receive wireless input from a network node via a wireless connection. In response to the received wireless input the states of the actuator, the motor, or the switch may change. For example, the UE may comprise a motor that adjusts the control surfaces or rotors of a drone in flight according to the received input or controls a robotic arm performing a medical procedure according to the received input.

A UE, when in the form of an Internet of Things (IoT) device, may be a device for use in one or more application domains, these domains comprising, but not limited to, city wearable technology, extended industrial application and healthcare. Non-limiting examples of such an IoT device are devices which are or which are embedded in: a connected refrigerator or freezer, a TV, a connected lighting device, an electricity meter, a robot vacuum cleaner, a voice controlled smart speaker, a home security camera, a motion detector, a thermostat, a smoke detector, a door/window sensor, a flood/moisture sensor, an electrical door lock, a connected doorbell, an air conditioning system like a heat pump, an autonomous vehicle, a surveillance system, a weather monitoring device, a vehicle parking monitoring device, an electric vehicle charging station, a smart watch, a fitness tracker, a head-mounted display for Augmented Reality (AR) or Virtual Reality (VR), a wearable for tactile augmentation or sensory enhancement, a water sprinkler, an animal- or item-tracking device, a sensor for monitoring a plant or animal, an industrial robot, an Unmanned Aerial Vehicle (UAV), and any kind of medical device, like a heart rate monitor or a remote controlled surgical robot. A UE in the form of an IoT device comprises circuitry and/or software in dependence on the intended application of the IoT device in addition to other components as described in relation to the UE QQ200 shown in FIG. 7.

As yet another specific example, in an IoT scenario, a UE may represent a machine or other device that performs monitoring and/or measurements, and transmits the results of such monitoring and/or measurements to another UE and/or a network node. The UE may in this case be an M2M device, which may in a 3GPP context be referred to as an MTC device. As one particular example, the UE may implement the 3GPP NB-IoT standard. In other scenarios, a UE may represent a vehicle, such as a car, a bus, a truck, a ship and an airplane, or other equipment that is capable of monitoring and/or reporting on its operational status or other functions associated with its operation.

In practice, any number of UEs may be used together with respect to a single use case. For example, a first UE might be or be integrated in a drone and provide the drone's speed information (obtained through a speed sensor) to a second UE that is a remote controller operating the drone. When the user makes changes from the remote controller, the first UE may adjust the throttle on the drone (e.g. by controlling an actuator) to increase or decrease the drone's speed. The first and/or the second UE can also include more than one of the functionalities described above. For example, a UE might comprise the sensor and the actuator, and handle communication of data for both the speed sensor and the actuators.

FIG. 8 shows a network node QQ300 in accordance with some embodiments. As used herein, network node refers to equipment capable, configured, arranged and/or operable to communicate directly or indirectly with a UE and/or with other network nodes or equipment, in a telecommunication network. Examples of network nodes include, but are not limited to, access points (APs) (e.g. radio access points), base stations (BSs) (e.g. radio base stations, Node Bs, evolved Node Bs (eNBs) and NR NodeBs (gNBs)).

Base stations may be categorized based on the amount of coverage they provide (or, stated differently, their transmit power level) and so, depending on the provided amount of coverage, may be referred to as femto base stations, pico base stations, micro base stations, or macro base stations. A base station may be a relay node or a relay donor node controlling a relay. A network node may also include one or more (or all) parts of a distributed radio base station such as centralized digital units and/or remote radio units (RRUs), sometimes referred to as Remote Radio Heads (RRHs). Such remote radio units may or may not be integrated with an antenna as an antenna integrated radio. Parts of a distributed radio base station may also be referred to as nodes in a distributed antenna system (DAS).

Other examples of network nodes include multiple transmission point (multi-TRP) 5G access nodes, multi-standard radio (MSR) equipment such as MSR BSs, network controllers such as radio network controllers (RNCs) or base station controllers (BSCs), base transceiver stations (BTSs), transmission points, transmission nodes, multi-cell/multicast coordination entities (MCEs), Operation and Maintenance (O&M) nodes, Operations Support System (OSS) nodes, Self-Organizing Network (SON) nodes, positioning nodes (e.g. Evolved Serving Mobile Location Centers (E-SMLCs)), and/or Minimization of Drive Tests (MDTs).

The network node QQ300 includes processing circuitry QQ302, a memory QQ304, a communication interface QQ306, and a power source QQ308, and/or any other component, or any combination thereof. The network node QQ300 may be composed of multiple physically separate components (e.g. a NodeB component and a RNC component, or a BTS component and a BSC component, etc.), which may each have their own respective components. In certain scenarios in which the network node QQ300 comprises multiple separate components (e.g. BTS and BSC components), one or more of the separate components may be shared among several network nodes. For example, a single RNC may control multiple NodeBs. In such a scenario, each unique NodeB and RNC pair, may in some instances be considered a single separate network node. In some embodiments, the network node QQ300 may be configured to support multiple radio access technologies (RATs). In such embodiments, some components may be duplicated (e.g. separate memory QQ304 for different RATs) and some components may be reused (e.g. a same antenna QQ310 may be shared by different RATs). The network node QQ300 may also include multiple sets of the various illustrated components for different wireless technologies integrated into network node QQ300, for example GSM, WCDMA, LTE, NR, WiFi, Zigbee, Z-wave, LoRaWAN, Radio Frequency Identification (RFID) or Bluetooth wireless technologies. These wireless technologies may be integrated into the same or different chip or set of chips and other components within network node QQ300.

The processing circuitry QQ302 may comprise a combination of one or more of a microprocessor, controller, microcontroller, central processing unit, digital signal processor, application-specific integrated circuit, field programmable gate array, or any other suitable computing device, resource, or combination of hardware, software and/or encoded logic operable to provide, either alone or in conjunction with other network node QQ300 components, such as the memory QQ304, network node QQ300 functionality. For example, the processing circuitry QQ302 may be configured to cause the network node to perform the methods as described with reference to FIGS. 3 and/or 4.

In some embodiments, the processing circuitry QQ302 includes a system on a chip (SOC). In some embodiments, the processing circuitry QQ302 includes one or more of radio frequency (RF) transceiver circuitry QQ312 and baseband processing circuitry QQ314. In some embodiments, the radio frequency (RF) transceiver circuitry QQ312 and the baseband processing circuitry QQ314 may be on separate chips (or sets of chips), boards, or units, such as radio units and digital units. In alternative embodiments, part or all of RF transceiver circuitry QQ312 and baseband processing circuitry QQ314 may be on the same chip or set of chips, boards, or units.

The memory QQ304 may comprise any form of volatile or non-volatile computer-readable memory including, without limitation, persistent storage, solid-state memory, remotely mounted memory, magnetic media, optical media, random access memory (RAM), read-only memory (ROM), mass storage media (for example, a hard disk), removable storage media (for example, a flash drive, a Compact Disk (CD) or a Digital Video Disk (DVD)), and/or any other volatile or non-volatile, non-transitory device-readable and/or computer-executable memory devices that store information, data, and/or instructions that may be used by the processing circuitry QQ302. The memory QQ304 may store any suitable instructions, data, or information, including a computer program, software, an application including one or more of logic, rules, code, tables, and/or other instructions capable of being executed by the processing circuitry QQ302 and utilized by the network node QQ300. The memory QQ304 may be used to store any calculations made by the processing circuitry QQ302 and/or any data received via the communication interface QQ306. In some embodiments, the processing circuitry QQ302 and memory QQ304 is integrated.

The communication interface QQ306 is used in wired or wireless communication of signaling and/or data between a network node, access network, and/or UE. As illustrated, the communication interface QQ306 comprises port(s)/terminal(s) QQ316 to send and receive data, for example to and from a network over a wired connection. The communication interface QQ306 also includes radio front-end circuitry QQ318 that may be coupled to, or in certain embodiments a part of, the antenna QQ310. Radio front-end circuitry QQ318 comprises filters QQ320 and amplifiers QQ322. The radio front-end circuitry QQ318 may be connected to an antenna QQ310 and processing circuitry QQ302. The radio front-end circuitry may be configured to condition signals communicated between antenna QQ310 and processing circuitry QQ302. The radio front-end circuitry QQ318 may receive digital data that is to be sent out to other network nodes or UEs via a wireless connection. The radio front-end circuitry QQ318 may convert the digital data into a radio signal having the appropriate channel and bandwidth parameters using a combination of filters QQ320 and/or amplifiers QQ322. The radio signal may then be transmitted via the antenna QQ310. Similarly, when receiving data, the antenna QQ310 may collect radio signals which are then converted into digital data by the radio front-end circuitry QQ318. The digital data may be passed to the processing circuitry QQ302. In other embodiments, the communication interface may comprise different components and/or different combinations of components.

In certain alternative embodiments, the network node QQ300 does not include separate radio front-end circuitry QQ318, instead, the processing circuitry QQ302 includes radio front-end circuitry and is connected to the antenna QQ310. Similarly, in some embodiments, all or some of the RF transceiver circuitry QQ312 is part of the communication interface QQ306. In still other embodiments, the communication interface QQ306 includes one or more ports or terminals QQ316, the radio front-end circuitry QQ318, and the RF transceiver circuitry QQ312, as part of a radio unit (not shown), and the communication interface QQ306 communicates with the baseband processing circuitry QQ314, which is part of a digital unit (not shown).

The antenna QQ310 may include one or more antennas, or antenna arrays, configured to send and/or receive wireless signals. The antenna QQ310 may be coupled to the radio front-end circuitry QQ318 and may be any type of antenna capable of transmitting and receiving data and/or signals wirelessly. In certain embodiments, the antenna QQ310 is separate from the network node QQ300 and connectable to the network node QQ300 through an interface or port.

The antenna QQ310, communication interface QQ306, and/or the processing circuitry QQ302 may be configured to perform any receiving operations and/or certain obtaining operations described herein as being performed by the network node. Any information, data and/or signals may be received from a UE, another network node and/or any other network equipment. Similarly, the antenna QQ310, the communication interface QQ306, and/or the processing circuitry QQ302 may be configured to perform any transmitting operations described herein as being performed by the network node. Any information, data and/or signals may be transmitted to a UE, another network node and/or any other network equipment.

The power source QQ308 provides power to the various components of network node QQ300 in a form suitable for the respective components (e.g. at a voltage and current level needed for each respective component). The power source QQ308 may further comprise, or be coupled to, power management circuitry to supply the components of the network node QQ300 with power for performing the functionality described herein. For example, the network node QQ300 may be connectable to an external power source (e.g. the power grid, an electricity outlet) via an input circuitry or interface such as an electrical cable, whereby the external power source supplies power to power circuitry of the power source QQ308. As a further example, the power source QQ308 may comprise a source of power in the form of a battery or battery pack which is connected to, or integrated in, power circuitry. The battery may provide backup power should the external power source fail.

Embodiments of the network node QQ300 may include additional components beyond those shown in FIG. 8 for providing certain aspects of the network node's functionality, including any of the functionality described herein and/or any functionality necessary to support the subject matter described herein. For example, the network node QQ300 may include user interface equipment to allow input of information into the network node QQ300 and to allow output of information from the network node QQ300. This may allow a user to perform diagnostic, maintenance, repair, and other administrative functions for the network node QQ300.

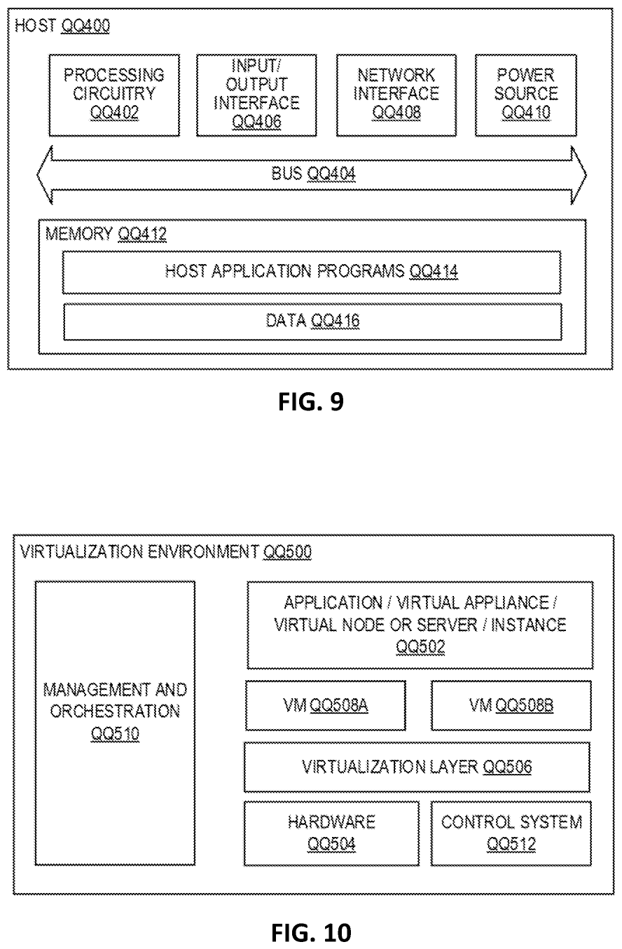

FIG. 9 is a block diagram of a host QQ400, which may be an embodiment of the host QQ116 of FIG. 6, in accordance with various aspects described herein. As used herein, the host QQ400 may be or comprise various combinations hardware and/or software, including a standalone server, a blade server, a cloud-implemented server, a distributed server, a virtual machine, container, or processing resources in a server farm. The host QQ400 may provide one or more services to one or more UEs.

The host QQ400 includes processing circuitry QQ402 that is operatively coupled via a bus QQ404 to an input/output interface QQ406, a network interface QQ408, a power source QQ410, and a memory QQ412. Other components may be included in other embodiments. Features of these components may be substantially similar to those described with respect to the devices of previous figures, such as FIGS. 7 and 8, such that the descriptions thereof are generally applicable to the corresponding components of host QQ400.

The memory QQ412 may include one or more computer programs including one or more host application programs QQ414 and data QQ416, which may include user data, e.g. data generated by a UE for the host QQ400 or data generated by the host QQ400 for a UE. Embodiments of the host QQ400 may utilize only a subset or all of the components shown. The host application programs QQ414 may be implemented in a container-based architecture and may provide support for video codecs (e.g. Versatile Video Coding (VVC), High Efficiency Video Coding (HEVC), Advanced Video Coding (AVC), MPEG, VP9) and audio codecs (e.g. FLAC, Advanced Audio Coding (AAC), MPEG, G.711), including transcoding for multiple different classes, types, or implementations of UEs (e.g. handsets, desktop computers, wearable display systems, heads-up display systems). The host application programs QQ414 may also provide for user authentication and licensing checks and may periodically report health, routes, and content availability to a central node, such as a device in or on the edge of a core network. Accordingly, the host QQ400 may select and/or indicate a different host for over-the-top services for a UE. The host application programs QQ414 may support various protocols, such as the HTTP Live Streaming (HLS) protocol, Real-Time Messaging Protocol (RTMP), Real-Time Streaming Protocol (RTSP), Dynamic Adaptive Streaming over HTTP (MPEG-DASH), etc.

FIG. 10 is a block diagram illustrating a virtualization environment QQ500 in which functions implemented by some embodiments may be virtualized. In the present context, virtualizing means creating virtual versions of apparatuses or devices which may include virtualizing hardware platforms, storage devices and networking resources. As used herein, virtualization can be applied to any device described herein, or components thereof, and relates to an implementation in which at least a portion of the functionality is implemented as one or more virtual components. Some or all of the functions described herein may be implemented as virtual components executed by one or more virtual machines (VMs) implemented in one or more virtual environments QQ500 hosted by one or more of hardware nodes, such as a hardware computing device that operates as a network node, UE, core network node, or host. Further, in embodiments in which the virtual node does not require radio connectivity (e.g. a core network node or host), then the node may be entirely virtualized.

Applications QQ502 (which may alternatively be called software instances, virtual appliances, network functions, virtual nodes, virtual network functions, etc.) are run in the virtualization environment Q400 to implement some of the features, functions, and/or benefits of some of the embodiments disclosed herein.

Hardware QQ504 includes processing circuitry, memory that stores software and/or instructions executable by hardware processing circuitry, and/or other hardware devices as described herein, such as a network interface, input/output interface, and so forth. Software may be executed by the processing circuitry to instantiate one or more virtualization layers QQ506 (also referred to as hypervisors or virtual machine monitors (VMMs)), provide VMs QQ508a and QQ508b (one or more of which may be generally referred to as VMs QQ508), and/or perform any of the functions, features and/or benefits described in relation with some embodiments described herein. The virtualization layer QQ506 may present a virtual operating platform that appears like networking hardware to the VMs QQ508.

The VMs QQ508 comprise virtual processing, virtual memory, virtual networking or interface and virtual storage, and may be run by a corresponding virtualization layer QQ506. Different embodiments of the instance of a virtual appliance QQ502 may be implemented on one or more of VMs QQ508, and the implementations may be made in different ways. Virtualization of the hardware is in some contexts referred to as network function virtualization (NFV). NFV may be used to consolidate many network equipment types onto industry standard high volume server hardware, physical switches, and physical storage, which can be located in data centers, and customer premise equipment.

In the context of NFV, a VM QQ508 may be a software implementation of a physical machine that runs programs as if they were executing on a physical, non-virtualized machine. Each of the VMs QQ508, and that part of hardware QQ504 that executes that VM, be it hardware dedicated to that VM and/or hardware shared by that VM with others of the VMs, forms separate virtual network elements. Still in the context of NFV, a virtual network function is responsible for handling specific network functions that run in one or more VMs QQ508 on top of the hardware QQ504 and corresponds to the application QQ502.

Hardware QQ504 may be implemented in a standalone network node with generic or specific components. Hardware QQ504 may implement some functions via virtualization. Alternatively, hardware QQ504 may be part of a larger cluster of hardware (e.g. such as in a data center or CPE) where many hardware nodes work together and are managed via management and orchestration QQ510, which, among others, oversees lifecycle management of applications QQ502. In some embodiments, hardware QQ504 is coupled to one or more radio units that each include one or more transmitters and one or more receivers that may be coupled to one or more antennas. Radio units may communicate directly with other hardware nodes via one or more appropriate network interfaces and may be used in combination with the virtual components to provide a virtual node with radio capabilities, such as a radio access node or a base station. In some embodiments, some signaling can be provided with the use of a control system QQ512 which may alternatively be used for communication between hardware nodes and radio units.

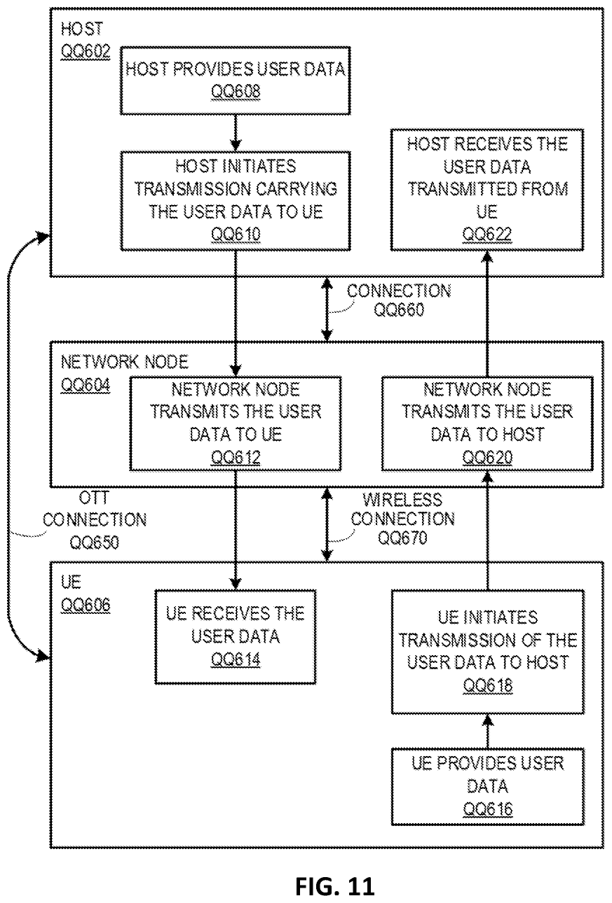

FIG. 11 shows a communication diagram of a host QQ602 communicating via a network node QQ604 with a UE QQ606 over a partially wireless connection in accordance with some embodiments. Example implementations, in accordance with various embodiments, of the UE (such as a UE QQ112a of FIG. 6 and/or UE QQ200 of FIG. 7), network node (such as network node QQ110a of FIG. 6 and/or network node QQ300 of FIG. 8), and host (such as host QQ116 of FIG. 6 and/or host QQ400 of FIG. 9) discussed in the preceding paragraphs will now be described with reference to FIG. 11.

Like host QQ400, embodiments of host QQ602 include hardware, such as a communication interface, processing circuitry, and memory. The host QQ602 also includes software, which is stored in or accessible by the host QQ602 and executable by the processing circuitry. The software includes a host application that may be operable to provide a service to a remote user, such as the UE QQ606 connecting via an over-the-top (OTT) connection QQ650 extending between the UE QQ606 and host QQ602. In providing the service to the remote user, a host application may provide user data which is transmitted using the OTT connection QQ650.

The network node QQ604 includes hardware enabling it to communicate with the host QQ602 and UE QQ606. The connection QQ660 may be direct or pass through a core network (like core network QQ106 of FIG. 6) and/or one or more other intermediate networks, such as one or more public, private, or hosted networks. For example, an intermediate network may be a backbone network or the Internet.

The UE QQ606 includes hardware and software, which is stored in or accessible by UE QQ606 and executable by the UE's processing circuitry. The software includes a client application, such as a web browser or operator-specific “app” that may be operable to provide a service to a human or non-human user via UE QQ606 with the support of the host QQ602. In the host QQ602, an executing host application may communicate with the executing client application via the OTT connection QQ650 terminating at the UE QQ606 and host QQ602. In providing the service to the user, the UE's client application may receive request data from the host's host application and provide user data in response to the request data. The OTT connection QQ650 may transfer both the request data and the user data. The UE's client application may interact with the user to generate the user data that it provides to the host application through the OTT connection QQ650.

The OTT connection QQ650 may extend via a connection QQ660 between the host QQ602 and the network node QQ604 and via a wireless connection QQ670 between the network node QQ604 and the UE QQ606 to provide the connection between the host QQ602 and the UE QQ606. The connection QQ660 and wireless connection QQ670, over which the OTT connection QQ650 may be provided, have been drawn abstractly to illustrate the communication between the host QQ602 and the UE QQ606 via the network node QQ604, without explicit reference to any intermediary devices and the precise routing of messages via these devices.

As an example of transmitting data via the OTT connection QQ650, in step QQ608, the host QQ602 provides user data, which may be performed by executing a host application. In some embodiments, the user data is associated with a particular human user interacting with the UE QQ606. In other embodiments, the user data is associated with a UE QQ606 that shares data with the host QQ602 without explicit human interaction. In step QQ610, the host QQ602 initiates a transmission carrying the user data towards the UE QQ606. The host QQ602 may initiate the transmission responsive to a request transmitted by the UE QQ606. The request may be caused by human interaction with the UE QQ606 or by operation of the client application executing on the UE QQ606. The transmission may pass via the network node QQ604, in accordance with the teachings of the embodiments described throughout this disclosure. Accordingly, in step QQ612, the network node QQ604 transmits to the UE QQ606 the user data that was carried in the transmission that the host QQ602 initiated, in accordance with the teachings of the embodiments described throughout this disclosure. In step QQ614, the UE QQ606 receives the user data carried in the transmission, which may be performed by a client application executed on the UE QQ606 associated with the host application executed by the host QQ602.

In some examples, the UE QQ606 executes a client application which provides user data to the host QQ602. The user data may be provided in reaction or response to the data received from the host QQ602. Accordingly, in step QQ616, the UE QQ606 may provide user data, which may be performed by executing the client application. In providing the user data, the client application may further consider user input received from the user via an input/output interface of the UE QQ606. Regardless of the specific manner in which the user data was provided, the UE QQ606 initiates, in step QQ618, transmission of the user data towards the host QQ602 via the network node QQ604. In step QQ620, in accordance with the teachings of the embodiments described throughout this disclosure, the network node QQ604 receives user data from the UE QQ606 and initiates transmission of the received user data towards the host QQ602. In step QQ622, the host QQ602 receives the user data carried in the transmission initiated by the UE QQ606.

One or more of the various embodiments improve the performance of OTT services provided to the UE QQ606 using the OTT connection QQ650, in which the wireless connection QQ670 forms the last segment. More precisely, the teachings of these embodiments may improve the performance of MT-SDT, and thereby provide benefits such as one or more of improved throughput, improved network efficiency, decreased latency, improved batter life, etc.

In an example scenario, factory status information may be collected and analyzed by the host QQ602. As another example, the host QQ602 may process audio and video data which may have been retrieved from a UE for use in creating maps. As another example, the host QQ602 may collect and analyze real-time data to assist in controlling vehicle congestion (e.g. controlling traffic lights). As another example, the host QQ602 may store surveillance video uploaded by a UE. As another example, the host QQ602 may store or control access to media content such as video, audio, VR or AR which it can broadcast, multicast or unicast to UEs. As other examples, the host QQ602 may be used for energy pricing, remote control of non-time critical electrical load to balance power generation needs, location services, presentation services (such as compiling diagrams etc. from data collected from remote devices), or any other function of collecting, retrieving, storing, analyzing and/or transmitting data.

In some examples, a measurement procedure may be provided for the purpose of monitoring data rate, latency and other factors on which the one or more embodiments improve. There may further be an optional network functionality for reconfiguring the OTT connection QQ650 between the host QQ602 and UE QQ606, in response to variations in the measurement results. The measurement procedure and/or the network functionality for reconfiguring the OTT connection may be implemented in software and hardware of the host QQ602 and/or UE QQ606. In some embodiments, sensors (not shown) may be deployed in or in association with other devices through which the OTT connection QQ650 passes; the sensors may participate in the measurement procedure by supplying values of the monitored quantities exemplified above, or supplying values of other physical quantities from which software may compute or estimate the monitored quantities. The reconfiguring of the OTT connection QQ650 may include message format, retransmission settings, preferred routing etc.; the reconfiguring need not directly alter the operation of the network node QQ604. Such procedures and functionalities may be known and practiced in the art. In certain embodiments, measurements may involve proprietary UE signaling that facilitates measurements of throughput, propagation times, latency and the like, by the host QQ602. The measurements may be implemented in that software causes messages to be transmitted, in particular empty or ‘dummy’ messages, using the OTT connection QQ650 while monitoring propagation times, errors, etc.

Although the computing devices described herein (e.g. UEs, network nodes, hosts) may include the illustrated combination of hardware components, other embodiments may comprise computing devices with different combinations of components. It is to be understood that these computing devices may comprise any suitable combination of hardware and/or software needed to perform the tasks, features, functions and methods disclosed herein. Determining, calculating, obtaining or similar operations described herein may be performed by processing circuitry, which may process information by, for example, converting the obtained information into other information, comparing the obtained information or converted information to information stored in the network node, and/or performing one or more operations based on the obtained information or converted information, and as a result of said processing making a determination. Moreover, while components are depicted as single boxes located within a larger box, or nested within multiple boxes, in practice, computing devices may comprise multiple different physical components that make up a single illustrated component, and functionality may be partitioned between separate components. For example, a communication interface may be configured to include any of the components described herein, and/or the functionality of the components may be partitioned between the processing circuitry and the communication interface. In another example, non-computationally intensive functions of any of such components may be implemented in software or firmware and computationally intensive functions may be implemented in hardware.

This disclosure includes the following enumerated embodiments.

### Group B Embodiments

1. A method performed by a network node for forwarding data to a RAN node for transmitting a Mobile Terminated Small Data Transmission (MT-SDT) to a User Equipment (UE), the method comprising:
   determining data to be sent to a User Equipment (UE) in a Mobile Terminated Small Data Transmission (MT-SDT);
   sending, to a first Radio Access Network (RAN) node associated with a last serving cell for the UE, a paging request and an indication that the data is pending;
   determining that the UE has responded to the paging request; and
   forwarding the data to a second RAN node for transmitting the MT-SDT to the UE, wherein the second RAN node is associated with a cell that received a response to the paging request from the UE.
2. The method of embodiment 1, wherein the first RAN node is the same RAN node as the second RAN node.
3. The method of embodiment 2, wherein:
   the last serving cell is the same as the cell that received the response to the paging request from the UE; or
   the last serving cell is the same as the cell that received the response to the paging request from the UE.
4. The method of embodiment 2 or 3, wherein determining that the UE has responded to the paging request comprises at least one of:
   receiving, from the first RAN node, an indication that the UE has responded to the paging request;
   receiving, from the first RAN node, an indication that the UE is camping on the cell that received the response to the paging request from the UE;
   receiving, from the first RAN node, an indication that the cell that received the response to the paging request from the UE is a serving cell or a current serving cell for the UE; and/or
   receiving, from the first RAN node, an indication that the UE has connected to or resumed in the first RAN node.
5. The method of embodiment 1, wherein the first RAN node is a different RAN node to the second RAN node.
6. The method of embodiment 5, wherein determining that the UE has responded to the paging request comprises at least one of:
   receiving a path switch request for the UE from the first or second RAN node;
   receiving an indication from the first RAN node that the first RAN node has received, from the second RAN node, a request to retrieve a full or partial context of the UE;
   receiving, from the second RAN node, a request to retrieve a full or partial context of the UE from the first RAN node;
   receiving, from the second RAN node, an indication that the UE is camping on the cell that received the response to the paging request from the UE;
   receiving, from the second RAN node, an indication that the cell that received the response to the paging request from the UE is a serving cell or a current serving cell for the UE; and/or
   receiving, from the second RAN node, an indication that the UE has connected to or resumed in the second RAN node.
7. The method of embodiment 6, wherein determining that the UE has responded to the paging request comprises receiving, from the second RAN node, the request to retrieve the full or partial context of the UE from the first RAN node, and the method comprises:
   forwarding the request to retrieve the full or partial context to the second RAN node; and
   forwarding, to the first RAN node, a response to the request to retrieve the full or partial context.
8. The method of embodiment 7, comprising sending a path switch response message to the first RAN node.
9. The method of embodiments 1 to 8, wherein the indication that the data is pending comprises an indication that transmission of the MT-SDT to the UE is pending.
10. The method of any of embodiments 1 to 9, comprising sending, to the first RAN node, with the indication that the data is pending, information identifying UE expected traffic pattern or behavior after the data is transmitted to the UE.
11. The method of any of embodiments 1 to 10, wherein the paging request and/or the indication that the MT-SDT is pending are sent to the first RAN node in a NG Application Protocol (NGAP) message.
12. The method of any of embodiments 1 to 11, wherein determining that the UE has responded to the paging request comprises determining that the UE is in an active state, has resumed a connection to the second network node, and/or is reachable.
13. The method of any of embodiments 1 to 12, wherein determining that the UE has responded to the paging request comprises receiving an indication that the UE has responded to the paging request.
14. The method of embodiment 13, wherein the indication that the UE has responded to the paging request is received from the first RAN node or the second RAN node.
15. The method of any of embodiments 1 to 14, wherein the indication is sent in the paging request.
16. The method of any of embodiments 1 to 15, wherein the indication comprises an explicit indication.
17. The method of any of embodiments 1 to 16, wherein the paging request indicates an amount of data for transmission to the UE, and the indication comprises a non-zero amount of data.
18. The method of any of embodiments 1 to 17, wherein the indication comprises a service or bearer category and/or an indication of a Data Radio Bearer (DRB).
19. The method of any of embodiments 1 to 18, wherein the cell that received a response to the paging request from the UE comprises a current serving cell for the UE or a cell on which the UE is camped.
20. The method of any of embodiments 1 to 19, wherein the response from the UE to the paging request comprises a random access preamble, RRC resume request, RRC connection request, Msg1, Msg3 and/or MsgA.
21. The method of any of embodiments 1 to 20, wherein determining the data to be sent to the UE comprises receiving the data from another network node.
22. The method of any of embodiments 1 to 21, comprising buffering the data and/or the MT-SDT before forwarding the data to the second RAN node.
23. The method of any of embodiments 1 to 22, wherein forwarding the data to the second RAN node comprises forwarding the MT-SDT to the second RAN node for transmission to the UE.
24. The method of any of embodiments 1 to 23, wherein:
   the first RAN node comprises an anchor RAN node for the UE, a base station, base station control unit (CU), eNodeB (eNB), eNB-CU, gNodeB (gNB) or gNB-CU; and/or
   the second RAN node comprises an anchor RAN node for the UE, a base station, base station control unit (CU), eNodeB (eNB), eNB-CU, gNodeB (gNB) or gNB-CU.
25. The method of any of embodiments 1 to 24, wherein the network node comprises an Access and Mobility Management Function (AMF).
26. A method in a first Radio Access Network (RAN) node of causing transmission of a Mobile Terminated Small Data Transmission (MT-SDT) to a User Equipment (UE), the method comprising:
   receiving a paging request for a User Equipment (UE) and an indication that data is pending for transmission to the UE as a Mobile Terminated Small Data Transmission (MT-SDT);
   transmitting the paging request to the UE;
   determining that the UE has responded to the paging request; and
   causing the data to be forwarded from a network node to a second RAN node for transmitting the MT-SDT to the UE, wherein the second RAN node is associated with a cell that received a response to the paging request from the UE.
27. The method of embodiment 26, comprising receiving, from the UE, a response to the paging request.
28. The method of embodiment 27, wherein the first RAN node is the same RAN node as the second RAN node.
29. The method of embodiment 28, wherein causing the data to be forwarded from a network node to a second RAN node for transmitting the MT-SDT to the UE comprises forwarding an indication to the network node that the first RAN node has received the response to the paging request, and receiving the data or the MT-SDT from the network node.
30. The method of embodiment 29, comprising transmitting the MT-SDT to the UE.
31. The method of any of embodiments 27 to 30, wherein the first RAN node is not associated with a last serving cell for the UE, and the paging request is associated with another RAN node that is associated with the last serving cell for the UE, and wherein causing the data to be forwarded from a network node to a second RAN node for transmitting the MT-SDT to the UE comprises sending a request for a full or partial context for the UE to the another RAN node or the network node.
32. The method of embodiment 26, wherein the first RAN node a different RAN node to the second RAN node.
33. The method of embodiment 32, wherein the first RAN node is associated with a last serving cell for the UE.
34. The method of embodiment 32 or 33, wherein determining that the UE has responded to the paging request comprises receiving, from the network node or the second RAN node, a request to retrieve a full or partial context for the UE.
35. The method of embodiment 34, wherein causing the data to be forwarded from a network node to a second RAN node for transmitting the MT-SDT to the UE comprises sending, to the network node, an indication that the request to retrieve the full or partial context of the UE has been received from the second RAN node.
36. The method of any of embodiments 26 to 35, wherein causing the data to be forwarded from a network node to a second RAN node for transmitting the MT-SDT to the UE comprises at least one of:
   sending, to the network node, an indication that the UE has responded to the paging request;
   sending, to the network node, an indication that the UE is camping on the cell that received the response to the paging request from the UE;
   sending, to the network node, an indication that the cell that received the response to the paging request from the UE is a serving cell or a current serving cell for the UE;
   sending, to the network node, an indication that the UE has connected to or resumed in the second RAN node; and/or sending a path switch request to the network node.
37. The method of any of embodiments 26 to 36, comprising receiving the paging request from the network node, the second RAN node, or another RAN node.
38. The method of embodiment 37, wherein the another RAN node is associated with the last serving cell for the UE.
39. The method of embodiments 26 to 38, wherein the indication that the data is pending comprises an indication that transmission of the MT-SDT to the UE is pending.
40. The method of any of embodiments 26 to 39, comprising receiving, from the network node, with the indication that the data is pending, information identifying UE expected traffic pattern or behavior after the data is transmitted to the UE.
41. The method of any of embodiments 26 to 40, wherein the paging request and/or the indication that the MT-SDT is pending are received from the network node in a NG Application Protocol (NGAP) message.
42. The method of any of embodiments 26 to 41, wherein the indication is received in the paging request.
43. The method of any of embodiments 26 to 42, wherein the indication comprises an explicit indication.
44. The method of any of embodiments 26 to 43, wherein the paging request indicates an amount of data for transmission to the UE, and the indication comprises a non-zero amount of data.
45. The method of any of embodiments 26 to 44, wherein the indication comprises a service or bearer category and/or an indication of a Data Radio Bearer (DRB).
46. The method of any of embodiments 26 to 45, wherein the response from the UE to the paging request comprises a random access preamble, RRC resume request, RRC connection request, Msg1, Msg3 and/or MsgA.
47. The method of any of embodiments 1 to 23, wherein:
   the first RAN node comprises an anchor RAN node for the UE, a base station, base station control unit (CU), eNodeB (eNB), eNB-CU, gNodeB (gNB) or gNB-CU; and/or
   the second RAN node comprises an anchor RAN node for the UE, a base station, base station control unit (CU), eNodeB (eNB), eNB-CU, gNodeB (gNB) or gNB-CU.
48. The method of any of embodiments 1 to 24, wherein the network node comprises an Access and Mobility Management Function (AMF).
49. The method of any of the previous embodiments, further comprising:
   obtaining user data; and
   forwarding the user data to a host or a user equipment.

### Group C Embodiments

50. A network node comprising:
processing circuitry configured to cause the network node to perform any of the steps of any of the Group B embodiments;
power supply circuitry configured to supply power to the processing circuitry.
51. A host configured to operate in a communication system to provide an over-the-top (OTT) service, the host comprising:
processing circuitry configured to provide user data; and
a network interface configured to initiate transmission of the user data to a network node in a cellular network for transmission to a user equipment (UE), the network node having a communication interface and processing circuitry, the processing circuitry of the network node configured to perform any of the operations of any of the Group B embodiments to transmit the user data from the host to the UE.
52. The host of the previous embodiment, wherein:
the processing circuitry of the host is configured to execute a host application that provides the user data; and
the UE comprises processing circuitry configured to execute a client application associated with the host application to receive the transmission of user data from the host.
53. A method implemented in a host configured to operate in a communication system that further includes a network node and a user equipment (UE), the method comprising: providing user data for the UE; and
initiating a transmission carrying the user data to the UE via a cellular network comprising the network node, wherein the network node performs any of the operations of any of the Group B embodiments to transmit the user data from the host to the UE.
54. The method of the previous embodiment, further comprising, at the network node, transmitting the user data provided by the host for the UE.
55. The method of any of the previous 2 embodiments, wherein the user data is provided at the host by executing a host application that interacts with a client application executing on the UE, the client application being associated with the host application.
56. A communication system configured to provide an over-the-top service, the communication system comprising:
a host comprising:
processing circuitry configured to provide user data for a user equipment (UE), the user data being associated with the over-the-top service; and
a network interface configured to initiate transmission of the user data toward a cellular network node for transmission to the UE, the network node having a communication interface and processing circuitry, the processing circuitry of the network node configured to perform any of the operations of any of the Group B embodiments to transmit the user data from the host to the UE.
57. The communication system of the previous embodiment, further comprising: the network node; and/or the user equipment.
58. A host configured to operate in a communication system to provide an over-the-top (OTT) service, the host comprising:
processing circuitry configured to initiate receipt of user data; and
a network interface configured to receive the user data from a network node in a cellular network, the network node having a communication interface and processing circuitry, the processing circuitry of the network node configured to perform any of the operations of any of the Group B embodiments to receive the user data from a user equipment (UE) for the host.
59. The host of the previous embodiment, wherein:
the processing circuitry of the host is configured to execute a host application, thereby providing the user data; and
the host application is configured to interact with a client application executing on the UE, the client application being associated with the host application.
60. The host of the any of the previous 2 embodiments, wherein the initiating receipt of the user data comprises requesting the user data.
61. A method implemented by a host configured to operate in a communication system that further includes a network node and a user equipment (UE), the method comprising: at the host, initiating receipt of user data from the UE, the user data originating from a transmission which the network node has received from the UE, wherein the network node performs any of the steps of any of the Group B embodiments to receive the user data from the UE for the host.
62. The method of the previous embodiment, further comprising at the network node, transmitting the received user data to the host.

In certain embodiments, some or all of the functionality described herein may be provided by processing circuitry executing instructions stored on in memory, which in certain embodiments may be a computer program product in the form of a non-transitory computer-readable storage medium. In alternative embodiments, some or all of the functionality may be provided by the processing circuitry without executing instructions stored on a separate or discrete device-readable storage medium, such as in a hard-wired manner. In any of those particular embodiments, whether executing instructions stored on a non-transitory computer-readable storage medium or not, the processing circuitry can be configured to perform the described functionality. The benefits provided by such functionality are not limited to the processing circuitry alone or to other components of the computing device, but are enjoyed by the computing device as a whole, and/or by end users and a wireless network generally.

1-42. (canceled)

43. A method performed by a network node for forwarding data to a Radio Access Network (RAN) node for transmitting a Mobile Terminated Small Data Transmission (MT-SDT) to a User Equipment (UE), the method comprising:
determining data to be sent to the UE in the MT-SDT;
sending, to a first RAN node associated with a last serving cell for the UE, a paging request and an indication that the data is pending;
determining that the UE has responded to the paging request; and
forwarding the data to a second RAN node for transmitting the MT-SDT to the UE, wherein the second RAN node is associated with a cell that received a response to the paging request from the UE.

44. The method of claim 43, wherein the first RAN node is the same RAN node as the second RAN node, and determining that the UE has responded to the paging request comprises at least one of:
receiving, from the first RAN node, an indication that the UE has responded to the paging request;
receiving, from the first RAN node, an indication that the UE is camping on the cell that received the response to the paging request from the UE;
receiving, from the first RAN node, an indication that the cell that received the response to the paging request from the UE is a serving cell or a current serving cell for the UE; or
receiving, from the first RAN node, an indication that the UE has connected to or resumed in the first RAN node.

45. The method of claim 43, wherein the first and second RAN nodes are different nodes, and wherein determining that the UE has responded to the paging request comprises at least one of:
receiving a path switch request for the UE from the first or second RAN node;
receiving an indication from the first RAN node that the first RAN node has received, from the second RAN node, a request to retrieve a full or partial context of the UE;
receiving, from the second RAN node, a request to retrieve a full or partial context of the UE from the first RAN node;
receiving, from the second RAN node, an indication that the UE is camping on the cell that received the response to the paging request from the UE;
receiving, from the second RAN node, an indication that the cell that received the response to the paging request from the UE is a serving cell or a current serving cell for the UE; and/or
receiving, from the second RAN node, an indication that the UE has connected to or resumed in the second RAN node.

46. The method of claim 45, wherein determining that the UE has responded to the paging request comprises receiving, from the second RAN node, the request to retrieve the full or partial context of the UE from the first RAN node, and the method comprises:
forwarding the request to retrieve the full or partial context to the second RAN node; and
forwarding, to the first RAN node, a response to the request to retrieve the full or partial context.

47. The method of claim 43, comprising sending, to the first RAN node, with the indication that the data is pending, information identifying UE expected traffic pattern or behavior after the data is transmitted to the UE.

48. The method of claim 43, wherein at least one of the paging request and the indication that the data is pending is sent to the first RAN node in a NG Application Protocol (NGAP) message.

49. The method of claim 43, wherein determining that the UE has responded to the paging request comprises at least one of: receiving an indication that the UE has responded to the paging request, determining that the UE is in an active state, determining that the UE has resumed a connection to the second network node, or determining that the UE is reachable.

50. The method of claim 49, wherein the indication that the UE has responded to the paging request is received from the first RAN node or the second RAN node.

51. The method of claim 43, wherein the indication that the data is pending is sent in the paging request.

52. The method of claim 43, wherein the paging request indicates a non-zero amount of data for transmission to the UE.

53. The method of claim 43, wherein the indication that the data is pending comprises a service or bearer category and/or an indication of a Data Radio Bearer (DRB).

54. The method of claim 43, wherein the cell that received a response to the paging request from the UE comprises a current serving cell for the UE or a cell on which the UE is camped.

55. The method of claim 43, wherein the response from the UE to the paging request comprises any one or more of: a random access preamble, a Radio Resource Control (RRC) resume request, a RRC connection request, a Msg1, a Msg3, or a MsgA.

56. The method of claim 43, wherein determining the data to be sent to the UE comprises receiving the data from another network node.

57. The method of claim 43, wherein:
the first RAN node comprises an anchor RAN node for the UE, a base station, base station control unit (CU), eNodeB (eNB), eNB-CU, gNodeB (gNB) or gNB-CU;
the second RAN node comprises an anchor RAN node for the UE, a base station, base station control unit (CU), eNodeB (eNB), eNB-CU, gNodeB (gNB) or gNB-CU; and/or
the network node comprises an Access and Mobility Management Function (AMF).

58. A method in a first Radio Access Network (RAN) node, the method comprising:
receiving a paging request for a User Equipment (UE) and an indication that data is pending for transmission to the UE as a Mobile Terminated Small Data Transmission (MT-SDT);
transmitting the paging request to the UE;
determining that the UE has responded to the paging request; and
causing the data to be forwarded from a network node to a second RAN node for transmitting the MT-SDT to the UE, wherein the second RAN node is associated with a cell that received a response to the paging request from the UE.

59. The method of claim 58, wherein the first RAN node is not associated with a last serving cell for the UE, and the paging request is associated with another RAN node that is associated with the last serving cell for the UE, and wherein causing the data to be forwarded from a network node to a second RAN node for transmitting the MT-SDT to the UE comprises sending a request for a full or partial context for the UE to the another RAN node or the network node.

60. The method of claim 58, wherein determining that the UE has responded to the paging request comprises receiving, from the network node or the second RAN node, a request to retrieve a full or partial context for the UE.

61. A network node comprising:
a memory storing instructions; and
a processor configured to execute the instructions, whereby the network node is controlled to:
determine data to be sent to a User Equipment (UE) in a Mobile Terminated Small Data Transmission (MT-SDT);
send, to a first Radio Access Network (RAN) node associated with a last serving cell for the UE, a paging request and an indication that the data is pending;
determine that the UE has responded to the paging request; and
forward the data to a second RAN node for transmitting the MT-SDT to the UE, wherein the second RAN node is associated with a cell that received a response to the paging request from the UE.

62. A first Radio Access Network (RAN) node comprising:
a memory storing instructions; and
a processor configured to execute the instruction, whereby the first RAN node is controlled to:
transmit a paging request for a User Equipment (UE), in response to receiving the paging request and an indication that data is pending for transmission to the UE as a Mobile Terminated Small Data Transmission (MT-SDT);
determine that the UE has responded to the paging request; and
cause the data to be forwarded from a network node to a second RAN node for transmitting the MT-SDT to the UE, wherein the second RAN node is associated with a cell that received a response to the paging request from the UE.
